(19) United States
(12) Patent Application Publication
(10) Pub. No.: US 2001/0033048 A1
(43) Pub. Date: Oct. 25, 2001

(54) Stabilizer bar bushing for automotive vehicles, and manufacturing method for same

(76) Inventor: Shigeru Kamifuku, Kanagawa-ken (JP)

Correspondence Address: Jordan and Hamburg, 122 East 42nd Street, New York, NY, 10168, US

(21) Appl. No.: 09/728,530

(22) Filed: Dec. 1, 2000

(30) Foreign Application Priority Data
Dec. 1, 1999 (JP) 11-342262
Nov. 14, 2000 (JP) 2000-346684

(51) Int. Cl. B60G 11/20; B60G 21/04; F16F 1/14

(52) U.S. Cl. 267/189; 267/140.11; 267/276

(57) ABSTRACT

An automotive vehicle-use stabilizer bar (1) bushing is provided. The bushing (1) includes a generally cylindrical rubber-made elastic body (3) having formed therein in the center thereof an insertion hole (2) through which a stabilizer bar (200) is axially inserted. The above stabilizer bar bushing (1) is to be fixed with a mount bracket (103) to the body of the automotive vehicle with the insertion hole (2) being directed laterally of the vehicle body. The mount bracket (103) is applied on the outer circumference of the stabilizer bar bushing (1) and fastened to the vehicle body to secure the stabilizer bar bushing (1) to the vehicle body. Thus, the stabilizer bar bushing (1) will attenuate vibration by a portion thereof between the stabilizer bar (200) and vehicle body while allowing rotation and torsion of the stabilizer bar (200) in the insertion hole (2). A canvas or Teflon cloth (4) is attached to the inner surface of the insertion hole (2) with such a bonding strength that even as the stabilizer bar (200) repeatedly gives rotation and torsion thereof to the bushing (1), the canvas or Teflon cloth (4) will not be separated from the rubber-made elastic body (3).

### BACKGROUND OF THE INVENTION

1. Field of the Invention

The present invention relates to a stabilizer bar bushing for automotive vehicles.

2. Description of the Related Art

Generally, an automotive vehicle is provided with a stabilizer bar formed from a spring steel bar whose torsional rigidity reduces roll of the vehicle body when the vehicle is turning to improve the riding comfort and steering stability of the vehicle. The stabilizer bar consists of a torsional portion extending laterally of the vehicle and a pair of arms extending from opposite ends of the torsional portion longitudinally of the vehicle body, and thus the stabilizer bar is generally formed like a letter “U”. The torsional portion of the stabilizer bar is installed to the vehicle body by means of a bushing, while each of the arms is connected at the end thereof to one of a pair of right and left wheels by means of a suspension arm.

Referring now to FIG. 1, there is illustrated a sectional view of a conventional stabilizer bar bushing. As shown, a bushing 100, in which a torsional portion 200A of a stabilizer bar 200 is to be installed, is formed from an elastic cylinder 102 having an axial insertion hole 101 formed in the center thereof. With the torsional portion 200A of the stabilizer bar 200 being inserted through the insertion hole 101, a mount bracket 103 is applied on the Outer circumference of the stabilizer bar bushing 100 and fastened to a body 201 of an automotive vehicle to secure the stabilizer bar bushing 100 to the vehicle body 201.

The torsional rigidity of the torsional portion 200A of the stabilizer bar 200 acts to prevent one of a pair of right and left wheels of the vehicle from moving too much vertically in relation to the other, thereby reducing roll of the vehicle body 201 to improve the riding comfort and steering stability of the automotive vehicle. The bushing 100 inhibits vibration from being transmitted from the stabilizer bar 200 to the vehicle body 201 while allowing the torsional portion 200A of the stabilizer bar 200 to freely be deformed torsionally.

In the conventional stabilizer bar bushing, the elastic body thereof shrinks in a cold season such as winter and thus the inner surface of the insertion hole in the elastic body will not be able to follow rotation or torsional deformation of the torsional portion of the stabilizer bar, namely, the torsional portion will slip in the insertion hole, resulting in an abnormal sound. Also the slip causes abrasion of the inner surface of the insertion hole, thus possibly impairing the durability of the bushing. To avoid this, it has been proposed to attach a fabric on the inner surface of the insertion hole during vulcanization of the elastic body of the bushing. More specifically, during molding the elastic body from rubber by vulcanization, the fabric is partially embedded in the rubber under the pressure for injection of the rubber. Thus, the fabric will physically get entangled with the molded elastic body. However, just the vulcanization of the rubber for molding the elastic body with the fabric thus attached will assure no strong connection between the fabric and rubber. So, as the stabilizer bar repeatedly gives rotation and torsion thereof to the bushing while it is pressing and slipping the bushing, the fabric will be separated from the rubber which will thus be exposed.

### OBJECT AND SUMMARY OF THE INVENTION

The present invention has an object to overcome the above-mentioned drawbacks of the prior art by providing an automotive vehicle-use stabilizer bar bushing with less abrasion of the inner surface of an insertion hole formed therein and an improved durability, and a manufacturing method for the same.

The above object can be attained by providing an automotive vehicle-use stabilizer bar bushing including a generally cylindrical rubber-made elastic body having formed therein in the center thereof an insertion hole through which a stabilizer bar is axially inserted, a canvas or Teflon cloth being attached, according to the present invention, to the inner surface of the insertion hole with such a bonding strength that even as the stabilizer bar repeatedly gives rotation and torsion thereof to the bushing, the canvas or Teflon cloth will not be separated from the rubber-made elastic body.

The above stabilizer bar bushing is to be fixed with a mount bracket to the body of the automotive vehicle with the insertion hole being directed laterally of the vehicle body. More specifically, the mount bracket is applied on the outer circumference of the stabilizer bar bushing and fastened to the vehicle body to secure the stabilizer bar bushing to the vehicle body. Thus, the stabilizer bar bushing will attenuate vibration transmitted from the vehicle body while allowing rotation and torsion of the stabilizer bar in the insertion hole. Since the canvas or Teflon cloth is strongly bonded to the inner surface of the insertion hole, it will not be separated from the insertion hole inner surface even if the stabilizer bar slips in the insertion hole, and thus the durability of the rubber-made elastic body can be prevented from being degraded. Also, there will not take place any abnormal sound which would take place due to the direct contact between the stabilizer bar and the rubber-made elastic body.

These objects and other objects, features, and advantages of the present invention will become more apparent from the following detailed description of the preferred embodiments of the present invention when taken in conjunction with the accompanying drawings. It should be noted that the present invention is not limited to the embodiments but can freely be modified without departing from the scope and spirit thereof defined in the claims given later.

### BRIEF DESCRIPTION OF THE DRAWINGS

FIG. 1 is a sectional view of a conventional stabilizer bush;

FIG. 2 is a front view of a preferred embodiment of the stabilizer bush according to the present invention;

FIG. 3 is a sectional view take along the line A-A in FIG. 2; and

FIG. 4 is a sectional view of a mold assembly for the stabilizer bar bushing according to the present invention.

### DETAILED DESCRIPTION OF THE PREFERRED EMBODIMENTS

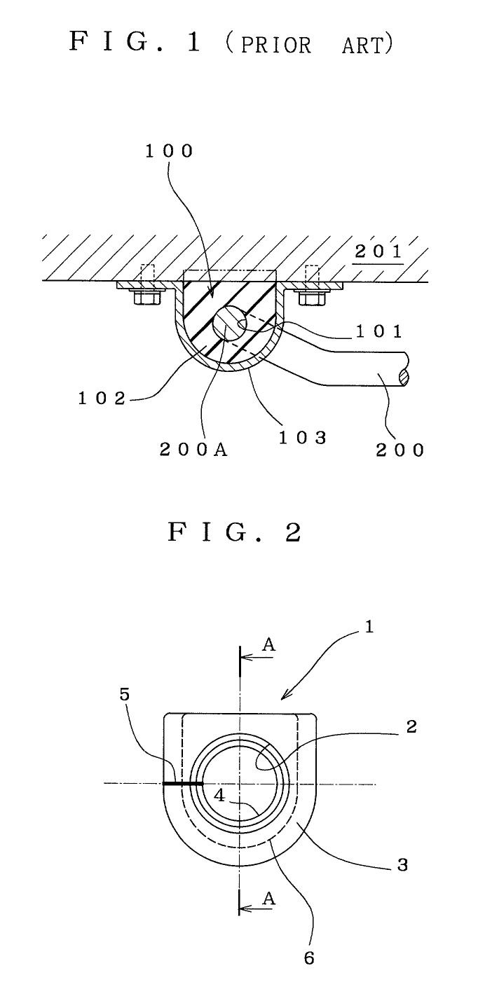

Referring now to FIG. 2, there is illustrated in the form of a front view the stabilizer bar bushing according to the present invention. The bushing is generally indicated with a reference 1. The bushing 1 includes a cylindrical rubber-made elastic body 3 having formed therein an insertion hole 2 through which a stabilizer bar 200 such as a conventional one shown in FIG. 1. The bushing 1 is to be fixed to the body of an automotive vehicle. There is attached to the inner surface of the insertion hole 2 in the rubber-made elastic body 3 a fibrous canvas 4 woven in the form of a mesh. The canvas 4 is chemically attached with an adhesive to the rubber-made elastic body 3. The rubber-made elastic body 3 has formed in the lateral side and along the entire length, thereof a cut 5 to insert the stabilizer bar 200 into the insertion hole 2. Note that a Teflon cloth or the like may be used instead of the canvas 4.

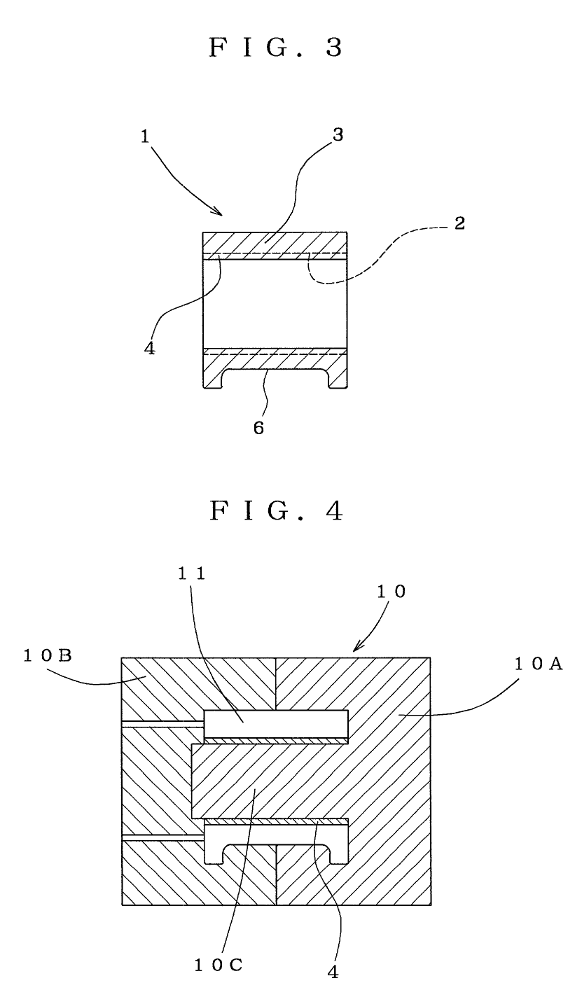

FIG. 3 is a sectional view taken along the line A-A in FIG. 2. With the adhesive previously applied on at least the outer side of the canvas or Teflon cloth 4, a rubber is molded by vulcanization on the outer surface of the canvas 4 to form the rubber-made elastic body 3. Thus, the rubber-made elastic body 3 and canvas 4 will be bonded chemically to each other. As in the conventional example having previously been described, a mount bracket 103 is applied on the outer circumference of the stabilizer bar bushing 1 and fastened to the vehicle body with the stabilizer bar 200 being inserted through the insertion hole 2. The mount bracket 103 is to be applied on a portion 6 of the stabilizer bar bushing 1 when securing the latter to the vehicle body, as shown in FIG. 3.

To manufacture the stabilizer bar bushing 1 as shown in FIGS. 2 and 3, a vulcanization-forming mold assembly shown in FIG. 4 is used. The mold assembly is generally indicated with a reference 10. The mold assembly 10 consists of a first mold 10A and a second mold 10B. The first mold 10A has a cylindrical code 10C. The space defined by the first and second molds 10A and 10B and the code 10C forms a cavity 11. Before the first and second molds 10A and 10B are closed, the canvas or Teflon cloth 4 is wound on the code 10C and the adhesive is applied to the outer side of the canvas 4. After winding the canvas 4 on the code 10C, the first and second molds 10A and 10B are closed. In this condition, a rubber is injected into the cavity 11. The injected rubber is vulcanized to form or mold the elastic body 3. The canvas 4 will chemically be bonded to the rubber-made elastic body 3 after the latter is molded.

Note that the adhesive may be applied to the outer side as well as the inner side of the canvas 4. When the rubber is vulcanized for molding with the adhesive applied to both sides of the canvas 4, no excess rubber will come out to the inner side of the canvas 4 under the pressure of the rubber injection. Thus, any abnormal sound can be prevented from taking place at the stabilizer bar bushing when the automotive vehicle is turning.

What is claimed is:

1. An automotive vehicle-use stabilizer bar bushing comprising:
a generally cylindrical rubber-made elastic body having formed therein in the center thereof an insertion hole through which a stabilizer bar is axially inserted, the rubber-made elastic body being to be fixed to the body of the automotive vehicle with the insertion hole being directed laterally of the vehicle body, with a mount bracket applied on the outer circumference of the rubber-made elastic body and fastened to the vehicle body to secure the stabilizer bar bushing to the vehicle body, thus the stabilizer bar bushing attenuating vibration transmitted from the vehicle body while allowing rotation and torsion of the stabilizer bar in the insertion hole;
a canvas or Teflon cloth attached to the inner surface of the insertion hole with such a bonding strength that even as the stabilizer bar repeatedly gives rotation and torsion thereof to the bushing, the canvas or Teflon cloth will not be separated from the rubber-made elastic body.

2. The stabilizer bar bushing as set forth in claim 1, wherein the canvas or Teflon cloth is a fibrous one woven in the form of a mesh and applied at at least a part thereof with an adhesive, and thus chemically attached to the inner surface of the insertion hole.

3. The stabilizer bar bushing as set forth in claim 1 or 2, wherein the adhesive is applied to both the side of the canvas or Teflon cloth at which it is put in contact with the rubber-made elastic body and the outer side opposite to the former side.

4. The stabilizer bar bushing as set forth in any one of claims 1 to 3, wherein the adhesive is applied to the entire inner surface of the insertion hole.

5. The stabilizer bar bushing as set forth in any one of claims 1 to 4, wherein a cut is formed in the lateral side and along the entire length, of the rubber-made elastic body.

6. The stabilizer bar bushing as set forth in any one of claims 1 to 4, wherein the canvas or Teflon cloth previously applied with the adhesive is disposed on a rubber before the latter is molded by vulcanization.

7. A method for manufacturing the stabilizer bar bushing set forth in claim 6, in which a cut is formed in the lateral side and along the entire length, of the rubber-made elastic body.
